(19) United States
(12) Patent Application Publication
(10) Pub. No.: US 2024/0088967 A1
(43) Pub. Date: Mar. 14, 2024

(54) CSI FEEDBACK FOR SINGLE DCI BASED MULTI-TRP TRANSMISSION

(71) Applicant: Telefonaktiebolaget LM Ericsson (publ), Stockholm (SE)

(72) Inventors: Shiwei Gao, Nepean (CA); Siva Muruganathan, Stittsville (CA)

(21) Appl. No.: 18/272,170

(22) PCT Filed: Jan. 17, 2022
(86) PCT No.: PCT/IB2022/050352

§ 371 Date: Jul. 13, 2023

Related U.S. Application Data
(60) Provisional application No. 63/138,731, filed on Jan. 18, 2021.
(60) Provisional application No. 63/138,253, filed on Jan. 15, 2021.

(51) Int. Cl. H04B 7/06

(52) U.S. Cl. CPC H04B 7/0626; H04B 7/063

(57) ABSTRACT

Systems and methods for CSI feedback are provided. In some embodiments, a method performed by a UE for CSI feedback for Non-Coherent Joint Transmission (NC-JT) Physical Downlink Shared Channel (PDSCH) transmission from multiple Transmission/Reception Points (TRPs) includes: receiving a CSI reporting setting comprising: a set of NZP CSI-RS resources for channel measurement including a first and second NZP CSI-RS resource for channel measurement; and a set of CSI-IM resources including a first and second CSI-IM resource for interference measurement; measuring interferences based on the CSI-IM resources, where the interferences are considered different instances of a same interference if a same set of receive antennas are used, and the interferences are considered different interferences if different sets of receive antennas are used; and computing and reporting CSI feedback comprising: a NC-JT CSI and a first single TRP CSI; or a NC-JT CSI; or a CRI and a second single TRP CSI.

### RELATED APPLICATIONS

This application claims the benefit of provisional patent application Ser. No. 63/138,253, filed Jan. 15, 2021, and provisional patent application serial number 63/138,731, filed Jan. 18, 2021, the disclosures of which are hereby incorporated herein by reference in their entireties.

### TECHNICAL FIELD

The present disclosure relates to Channel State Information (CSI) feedback.

### BACKGROUND

Third Generation Partnership Project (3GPP) New Radio (NR) uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example for 15 kHz subcarrier spacing is shown in FIG. 1 with a 14-symbol slot, where the first two symbols contain physical downlink control channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where μ ∈ {0, 1, 2, 3, 4}. Δf=15 kHz is the basic subcarrier spacing. The slot durations at different subcarrier spacings is given by 1/2^{μ} ms.

In the frequency domain, a system bandwidth is divided into Resource Blocks (RBs), each corresponds to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one resource element (RE).

### Channel State Information (CSI) and CSI Feedback

A core component in Long Term Evolution (LTE) and NR is the support of Multiple Input Multiple Output (MIMO) antenna deployments and MIMO related techniques. Spatial multiplexing is one of the MIMO techniques used to achieve high data rates in favorable channel conditions.

For an antenna array with N_{T} antenna ports at the gNB for transmitting rDL symbols s=[s₁, s₂, . . . ,sᵣ]^{T}, the received signal at a UE with N_{R} receive antennas at a certain RE n can be expressed as

yₙ=HₙWs+eₙ

where yₙ is a N_{R}×1 received signal vector; Hₙ a N_{R}×N_{T} channel matrix at the RE between the gNB and the UE; W is an N_{T}×r precoder matrix; eₙ is a N_{R}×1 noise plus interference vector received at the RE by the UE. The precoder W can be a wideband precoder, i.e., constant over a whole bandwidth part (BWP), or a subband precoder, i.e. constant over each subband.

The precoder matrix is typically selected from a codebook of possible precoder matrices, and typically reported by a precoder matrix Indicator (PMI), which specifies a unique precoder matrix in the codebook for a given number of symbol streams. Each of the r symbols in s corresponds to a spatial layer. r is referred to as the rank of the channel and is reported by a rank indicator (RI).

For a given block error rate (BLER), a modulation level and coding scheme (MCS) is determined by a UE based on the observed signal to noise and interference ratio (SINR), which is reported by a channel quality indicator (CQI). NR supports transmission of either one or two transport blocks (TBs) to a UE in a slot, depending on the rank. One TB is used for ranks 1 to 4, and two TBs are used for ranks 5 to 8. A CQI is associated to each TB. The CQI/RI/PMI report can be either wideband or subband based on configuration.

RI, PMI, and CQI are part of channel state information (CSI) and reported by a UE to a network node or gNB.

### Channel State Information Reference Signal (CSI-RS) and CSI-IM

A CSI-RS is transmitted on each transmit antenna port and is used by a UE to measure downlink channel associated with each of antenna ports. The antenna ports are also referred to as CSI-RS ports. The supported number of antenna ports in NR are {1, 2, 4, 8, 12, 16, 24, 32}. By measuring the received CSI-RS, a UE can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain REs per PRB. FIG. 3 shows an example of a NZP CSI-RS resource configuration in NR with four CSI-RS ports in a PRB in one slot.

In addition to NZP CSI-RS, Zero Power (ZP) CSI-RS was defined in NR to indicate to a UE that the associated REs are not available for PDSCH scheduling at the gNB. ZP CSI-RS can have the same RE patterns as NZP CSI-RS.

CSI resource for interference measurement, CSI-IM, is also defined in NR for a UE to measure noise and interference, typically from other cells. CSI-IM comprises of four REs in a slot. Two different CSI-IM patterns are defined: The CSI-IM pattern can be either four consecutive REs in one OFDM symbol or two consecutive REs in both frequency and time domains. An example is shown in FIG. 3. Typically, gNB does not transmit any signal in the CSI-IM resource so that what observed in the resource is noise and interference from other cells.

### CSI Framework in NR

In NR, a UE can be configured with one or multiple CSI report configurations. Each CSI report configuration (defined by a higher layer information element (IE) CSI-ReportConfig) is associated with a bandwidth part (BWP) and contains one or more of
a CSI resource configuration for channel measurement
a CSI-IM resource configuration for interference measurement
a NZP CSI-RS resource for interference measurement
reporting type, i.e., aperiodic CSI (on PUSCH), periodic CSI (on PUCCH) or semi-persistent CSI (on PUCCH, and DCI activated on PUSCH).
report quantity specifying what to be reported, such as RI, PMI, CQI
codebook configuration such as type I or type II CSI
frequency domain configuration, i.e., subband vs. wideband CQI or PMI, and subband size

The CSI-ReportConfiglE is shown in FIG. 4 according to the NR RRC specification 3GPP TS 38.331. Some parameters are omitted.

A UE can be configured with one or multiple CSI resource configurations each with a CSI-ResourceConfigId, for channel and interference measurement. Each CSI resource configuration for channel measurement or for NZP CSI-RS based interference measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

Periodic CSI starts after it has been configured by RRC and is reported on PUCCH, the associated NZP CSI-RS resource(s) and CSI-IM resource(s) are also periodic.

For semi-persistent CSI, it can be either on PUCCH or PUSCH. Semi-persistent CSI on PUCCH is activated or deactivated by a MAC CE command. Semi-persistent CSI on PUSCH is activated or deactivated by DCI. The associated NZP CSI-RS resource(s) and CSI-IM resource(s) can be either periodic or semi-persistent.

For aperiodic CSI, it is reported on PUSCH and is activated by a CSI request bit field in DCI. The associated NZP CSI-RS resource(s) and CSI-IM resource(s) can be either periodic, semi-persistent, or aperiodic. The linkage between a code point of the CSI request field and a CSI report configuration is via an aperiodic CSI trigger state. A UE is configured by higher layer a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI-IM resource set are associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In case multiple NZP CSI-RS resources are configured in a NZP CSI-RS resource set for channel measurement, the UE would select one NZP CSI-RS resource and report a CSI associated with selected NZP CSI-RS resource. A CRI (CSI-RS resource indicator) would be reported as part of the CSI. In this case, the same number of CSI-IM resources, each paired with a NZP CSI-RS resource need to be configured in the associated CSI-IM resource set. That is, when a UE reports a CRI value k, this corresponds to the (k+1)^{th} entry of the NZP CSI-RS resource set for channel measurement, and, if configured, the (k+l)^{th} entry of the CSI-IM resource set for interference measurement (clause 5.2.1.4.2 of 3GPP TS 38.214).

When NZP CSI-RS resource(s) are configured for interference measurement in a CSI-ReportConfig, only a single NZP-CSI-RS resource in a CSI-RS resource set can be configured for channel measurement in the same CSI-ReportConfig.

### Non-Coherent Joint Transmission (NC-JT) Over Multiple TRPs

In NR Rel-15, only PDSCH transmission from a single Transmission and Reception Point (TRP) is supported, in which a UE receives PDSCH from a single TRP at any given time.

In NR Rel-16, PDSCH transmission over multiple TRPs was introduced. One

of the multi-TRP scheme is NC-JT, in which a PDSCH to a UE in transmitted over two TRPs with different MIMO layers of the PDSCH transmitted from different TRPs. For example, two layers are transmitted from a first TRP and one layer from a second TRP.

Two flavors of NC-JT are supported, i.e., single DCI based N-JT and multi-DCI based NC-JT. In single DCI based NC-JT, it is assumed that a single scheduler is used to schedule data transmission over multiple TRPs, where different layers of a single PDSCH scheduled by a single PDCCH can be transmitted from different TRPs

In multi-DCI based NC-JT, independent schedulers are assumed in different TRPs to schedule PDSCHs to a UE. Two PDSCHs scheduled from two TRPs may be fully or partially overlapped in time and frequency resource. Only semi-static coordination between TRPs may be possible.

### OCL

Since the TRPs may be in different physical locations, the propagation channels to the UE can also be different. Different antennas or transmit beams are used in different TRPs. At the UE side, different receive antennas or receive beams may be used to receive from different TRPs. To facilitate receiving PDSCH from different TRPs, TCI (transmission configuration indicator) states were introduced in NR Rel-15.

A TCI state contains Quasi Co-location (QCL) information between a Demodulation Reference Signal (DMRS) for PDCCH or PDSCH and one or two DL reference signals such as a CSI-RS or an SSB. The supported QCL information types in NR are:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The QCL information is used by a UE to apply one or more channel properties estimated from the DL reference signals (CSI-RS or SSB) to channel estimation based on the DMRS for the PDSCH or PDCCH reception. For example, channel delay spread and Doppler shift parameters can be estimated from the QCL source RS, the estimation is then used for determining the channel filtering parameters for channel estimation based on the DMRS.

### Spatial Relation Definition

Spatial relation is used in NR to refer to a relationship between an UL reference signal (RS) to be transmitted such as PUCCH/PUSCH DMRS (demodulation reference signal) and another previously transmitted or received RS, which can be either a DL RS (CSI-RS (channel state information RS) or SSB (synchronization signal block)) or an UL RS (SRS (sounding reference signal)). This is also defined from a UE perspective.

If an UL transmitted RS is spatially related to a DL RS, it means that the UE should transmit the UL RS in the opposite (reciprocal) direction from which it received the DL RS previously. More precisely, the UE should apply the “same” Transmit (Tx) spatial filtering configuration for the transmission of the UL RS as the Rx spatial filtering configuration it used to receive the spatially related DL RS previously. Here, the terminology ‘spatial filtering configuration’ may refer to the antenna weights that are applied at either the transmitter or the receiver for data/control transmission/reception. Another way to describe this is that the same “beam” should be used to transmit the signal from the UE as was used to receive the previous DL RS signal. The DL RS is also referred as the spatial filter reference signal.

On the other hand, if a first UL RS is spatially related to a second UL RS, then the UE should apply the same Tx spatial filtering configuration for the transmission for the first UL RS as the Tx spatial filtering configuration it used to transmit the second UL RS previously. In other words, same beam is used to transmit the first and second UL RS respectively.

Since the UL RS is associated with a layer of PUSCH or PUCCH transmission, it is understood that the PUSCH/PUCCH is also transmitted with the same TX spatial filter as the associated UL RS.

### TCI States for Uplink

In NR Rel-15, the handling of spatial transmission properties is different for PUSCH, PUCCH, and SRS. For PUCCH, the spatial relation information is defined in information element PUCCH-SpatialRelationInfo, and the spatial relation information for SRS is configured as part of SRS resource configuration. The spatial transmission properties for PUSCH are given by the spatial transmission properties associated with the SRS(s) configured in SRS resource set with usage of ‘Codebook’ or ‘non-Codebook’. In NR Rel-16 MIMO discussions in 3GPP RANI, it was argued that the Rel-15 way of handling the spatial transmission properties is cumbersome and inflexible when it comes to uplink multi-panel transmission in NR. Hence, TCI states for uplink were proposed that can be used to control the spatial properties of all the UL transmissions (i.e., PUSCH, PUCCH, and SRS). The focus here was to be able to use uplink TCI state indication to select one of the uplink panels and the corresponding transmission beam (i.e., transmission properties) at the UE to transmit UL PUSCH/PUCCH/SRS when the UE is equipped with multiple panels. Improved systems and methods for CSI feedback are needed.

### SUMMARY

Systems and methods for Channel State Information (CSI) feedback are provided. In some embodiments, a method performed by a User Equipment (UE) for CSI feedback for Non-Coherent Joint Transmission (NC-JT) Physical Downlink Shared Channel (PDSCH) transmission from multiple Transmission/Reception Points (TRPs) includes: receiving, from a network node, a CSI reporting setting comprising: a set of Non-Zero Power (NZP) CSI Reference Signal (CSI-RS) resources for channel measurement, the set of NZP CSI-RS resources for channel measurement comprising a first NZP CSI-RS resource for channel measurement and a second NZP CSI-RS resource for channel measurement; and a set of CSI for Interference Measurement (CSI-IM) resources comprising a first CSI-IM resource for interference measurement and a second CSI-IM resource for interference measurement; measuring interferences based on the set of CSI-IM resources, where the interferences are considered different instances of a same interference if a same set of receive antennas are used for receiving a PDSCH from multiple TRPs, and the interferences are considered different interferences if different sets of receive antennas are used for receiving the PDSCH from the multiple TRPs; and computing and reporting CSI feedback comprising: a NC-JT CSI and a first single TRP CSI; or a NC-JT CSI; or a CRI and a second single TRP CSI.

Certain aspects of the present disclosure and their embodiments may provide solutions to the aforementioned or other challenges. In one embodiment, for computing NC-JT CSI, a UE considers the interferences measured in the multiple CSI-IM resources configured in a CSI-IM resource set as multiple instances of a same interference if same Rx antennas at the UE are used for receiving PDSCH from different TRPs. Otherwise, if different Rx antennas (e.g., different antenna panels) are used to receive PDSCH from different TRPs, then the UE considers the interferences measured in the multiple CSI-IM resources as difference interferences.

In another embodiment, NC-JT CSI may be reported together with single TRP CSI with shared RI and PMI, i.e., the RIs and PMIs in NC-JT CSI is assumed from single TRP CSI calculation.

In a further embodiment, either NC-JT CSI or single TRP CSI is reported.

Some example embodiments of the present disclosure are described in the numbered embodiments below:
1. A method of CSI feedback for NC-JT PDSCH transmission from two (or more) TRPs, the method comprising one or more of the following:
   Configuring, by a network node, the UE with a CSI reporting setting containing a first NZP CSI-RS resource and a second NZP CSI-RS resource for channel measurement and a first CSI-IM resource and a second CSI-IM resource for interference measurement, and a report quantity identifier indicating a NC-JT CSI report;
   Measuring, by the UE, interferences based on the first CSI-IM resource and the second CSI-IM resource where the interferences are considered different instances of a same interference if a same set of receive antennas are used for receiving a PDSCH from two (or more) TRPs, and the interferences are considered different interferences if different sets of receive antennas are used for receiving the PDSCH from the TRPs;
   Computing and Reporting, by the UE, one of:
      a NC-JT CSI and a first single TRP CSI,
      a NC-JT CSI,
      a CRI and a second single TRP CSI.
2. The method of embodiment 1 wherein the first CSI-IM resource is for measuring interference received on a first set of antenna ports for receiving the PDSCH from a first TRP associated with the first NZP CSI-RS resource, while the second CSI-IM is for measuring interference received on a second set of antenna ports for receiving the PDSCH from a second TRP associated with the second NZP CSI-RS resource.
3. The method of embodiment 1 or 2 wherein the NC-JT CSI comprises a first RI and a second RI, a first PMI and a second PMI, and a first CQI and in some cases a second CQI.
4. The method of embodiment 3 wherein the NC-JT CSI may further comprise a first CRI and/or a second CRI.
5. The method of any of embodiments 1 to 4 wherein the first single TRP CSI comprises a third RI, a third PMI, and a third CQI based on the first NZP CSI-RS resource and the first CSI-IM resource.
6. The method of embodiment 5 wherein the UE may assume that the third RI equals to the first RI, and the third PMI equals to the first PMI, wherein the third RI and PMI are not reported.
7. The method of embodiment 5 or 6 wherein the first single TRP CSI may further comprise a fourth RI, a fourth PMI, and a fourth CQI based on the second NZP CSI-RS resource and the second CSI-IM resource.
8. The method of embodiment 7 wherein the UE may assume that the fourth RI equals to the second RI, and the fourth PMI equals to the second PMI, wherein the fourth RI and PMI are not reported
9. The method of any of embodiments 5 to 8 wherein the first single TRP CSI may further comprises a first or a second CRI.
10.The method of any of embodiments 1 to 9 wherein the second single TRP CSI comprises the third RI, the third PMI, and the third CQI if CRI=0, and the fourth RI, the fourth PMI, and the fourth CQI if CRI=1.

There are, proposed herein, various embodiments which address one or more of the issues disclosed herein. In one embodiment, a method performed by a UE for CSI feedback for NJ-JT PDSCH transmission from multiple TRPs comprises one or more of the following: receiving, from a network node, a CSI reporting setting comprising a set of NZP CSI-RS resources for channel measurement that comprises a first NZP CSI-RS resource for channel measurement and a second NZP CSI-RS resource for channel measurement and a set of CSI-IM resources comprising a first CSI-IM resource for interference measurement and a second CSI-IM resource for interference measurement; measuring interferences based on the set of CSI-IM resources, where the interferences are considered different instances of a same interference if a same set of receive antennas are used for receiving a PDSCH from multiple TRPs, and the interferences are considered different interferences if different sets of receive antennas are used for receiving the PDSCH from the multiple TRPs; and computing and reporting CSI feedback comprising: a NC-JT CSI and a first single TRP CSI, or a NC-JT CSI, or a CRI and a second single TRP CSI.

In one embodiment, the CSI reporting setting further comprises a report quantity identifier indicating a NC-JT CSI report.

In one embodiment, the multiple TRPs comprise a first TRP and a second TRP, and measuring the interferences comprises measuring the interferences based on the first CSI-IM resource and the second CSI-IM resource where the interferences are considered different instances of a same interference if a same set of receive antennas are used for receiving the PDSCH from the first and second TRPs, and the interferences are considered different interferences if different sets of receive antennas are used for receiving the PDSCH from the first and second TRPs.

In one embodiment, the first CSI-IM resource is for measuring interference received on a first set of antenna ports for receiving the PDSCH from a first TRP associated with the first NZP CSI-RS resource, while the second CSI-IM is for measuring interference received on a second set of antenna ports for receiving the PDSCH from a second TRP associated with the second NZP CSI-RS resource.

In one embodiment, the NC-JT CSI comprises a first RI and a second RI, a first PMI and a second PMI, and a first CQI. In one embodiment, the NC-JT CSI further comprises a second CQI. In one embodiment, the NC-JT CSI further comprises a first CRI, or a second CRI, or both a first CRI and a second CRI.

In one embodiment, the first single TRP CSI comprises a third RI, a third PMI, and a third CQI based on the first NZP CSI-RS resource and the first CSI-IM resource. In one embodiment, the UE assume that the third RI equals to the first RI, and the third PMI equals to the first PMI, wherein the third RI and PMI are not reported. In one embodiment, the first single TRP CSI may further comprise a fourth RI, a fourth PMI, and a fourth CQI based on the second NZP CSI-RS resource and the second CSI-IM resource. In one embodiment, the UE may assume that the fourth RI equals to the second RI, and the fourth PMI equals to the second PMI, wherein the fourth RI and PMI are not reported. In one embodiment, the first single TRP CSI may further comprises a first CRI or a second CRI.

In one embodiment, the second single TRP CSI comprises the third RI, the third PMI, and the third CQI if an associated CRI is a first value (e.g., CRI=0), and comprises the fourth RI, the fourth PMI, and the fourth CQI if the associated CRI is a second value (e.g., CRI=1).

Corresponding embodiments of a UE are also disclosed.

In one embodiment, a method performed by a network node for configuration of reporting of CSI feedback for NC-JT PDSCH transmission from multiple TRPs comprises sending, to a UE, a CSI reporting setting comprising: a set of NZP CSI-RS resources for channel measurement, the set of NZP CSI-RS resources for channel measurement comprising a first NZP CSI-RS resource for channel measurement and a second NZP CSI-RS resource for channel measurement, and a set of CSI-IM resources comprising a first CSI-IM resource for interference measurement and a second CSI-IM resource for interference measurement.

In one embodiment, the CSI reporting setting further comprises a report quantity identifier indicating a NC-JT CSI report.

In one embodiment, the first CSI-IM resource is for measuring interference received on a first set of antenna ports for receiving a PDSCH from a first TRP associated with the first NZP CSI-RS resource, while the second CSI-IM is for measuring interference received on a second set of antenna ports for receiving the PDSCH from a second TRP associated with the second NZP CSI-RS resource.

In one embodiment, the method further comprises receiving CSI feedback from the UE, the CSI feedback comprising: a NC-JT CSI and a first single TRP CSI, or a NC-JT CSI, or a CRI and a second single TRP CSI.

In one embodiment, the NC-JT CSI comprises a first RI and a second RI, a first PMI and a second PMI, and a first CQI. In one embodiment, the NC-JT CSI further comprises a second CQI. In one embodiment, the NC-JT CSI further comprises a first CRI, or a second CRI, or both a first CRI and a second CRI.

In one embodiment, the first single TRP CSI comprises a third RI, a third PMI, and a third CQI based on the first NZP CSI-RS resource and the first CSI-IM resource. In one embodiment, the UE assume that the third RI equals to the first RI, and the third PMI equals to the first PMI, wherein the third RI and PMI are not reported. In one embodiment, the first single TRP CSI may further comprise a fourth RI, a fourth PMI, and a fourth CQI based on the second NZP CSI-RS resource and the second CSI-IM resource. In one embodiment, the UE may assume that the fourth RI equals to the second RI, and the fourth PMI equals to the second PMI, wherein the fourth RI and PMI are not reported. In one embodiment, the first single TRP CSI may further comprises a first CRI or a second CRI.

In one embodiment, the second single TRP CSI comprises the third RI, the third PMI, and the third CQI if an associated CRI is a first value (e.g., CRI=0), and comprises the fourth RI, the fourth PMI, and the fourth CQI if the associated CRI is a second value (e.g., CRI=1).

Corresponding embodiments of a network node are also disclosed.

Certain embodiments may provide one or more of the following technical advantage(s). Embodiments of the proposed solutions define how interference should be measured on one or more CSI-IM resources for a UE computing NC-JT CSI. Embodiments of the proposed solutions may reduce CSI feedback overhead. Embodiments of the proposed solutions may improve scheduling flexibility by including multiple CSI hypothesis in the CSI report while keeping the reporting overhead low at the same time.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in New Radio (NR) which is typically in slot basis;

FIG. 2 illustrates a basic NR physical time-frequency resource grid with only one Resource Block (RB) within a 14-symbol slot;

FIG. 3 shows an example of a NZP CSI-RS resource configuration in NR with four CSI-RS ports in a PRB in one slot;

FIG. 4 illustrates the CSI-ReportConfig IE according to the NR RRC specification 3GPP TS 38.331;

FIG. 5 illustrates one example of a cellular communications system 500 in which embodiments of the present disclosure may be implemented;

FIG. 6 illustrates a single centralized scheduler used to schedule PDSCH transmissions from two TRPs, according to some embodiments of the present disclosure;

FIG. 7A illustrates the operation of a network node and a UE for CSI feedback for single DCI based NC-JT, according to some embodiments of the present disclosure;

FIG. 7B illustrates the operation of a network node and a UE for CSI feedback, according to some embodiments of the present disclosure;

FIGS. 8 through 10 are schematic block diagrams of example embodiments of a radio access node, according to some embodiments of the present disclosure;

FIGS. 11 and 12 are schematic block diagrams of a UE, according to some embodiments of the present disclosure;

FIG. 13 illustrates an example embodiment of a communication system in which embodiments of the present disclosure may be implemented;

FIG. 14 illustrates example embodiments of the host computer, base station, and UE of FIG. 9, according to some embodiments of the present disclosure; and

FIGS. 15 through 18 are flow charts that illustrate example embodiments of methods implemented in a communication system such as that of FIG. 14, according to some embodiments of the present disclosure.

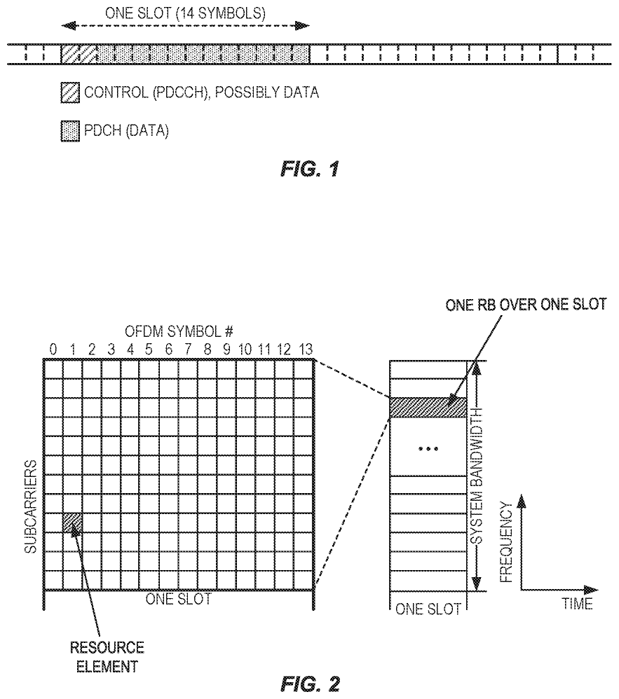

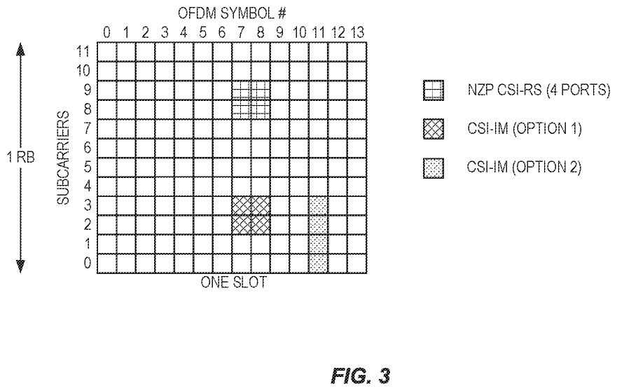

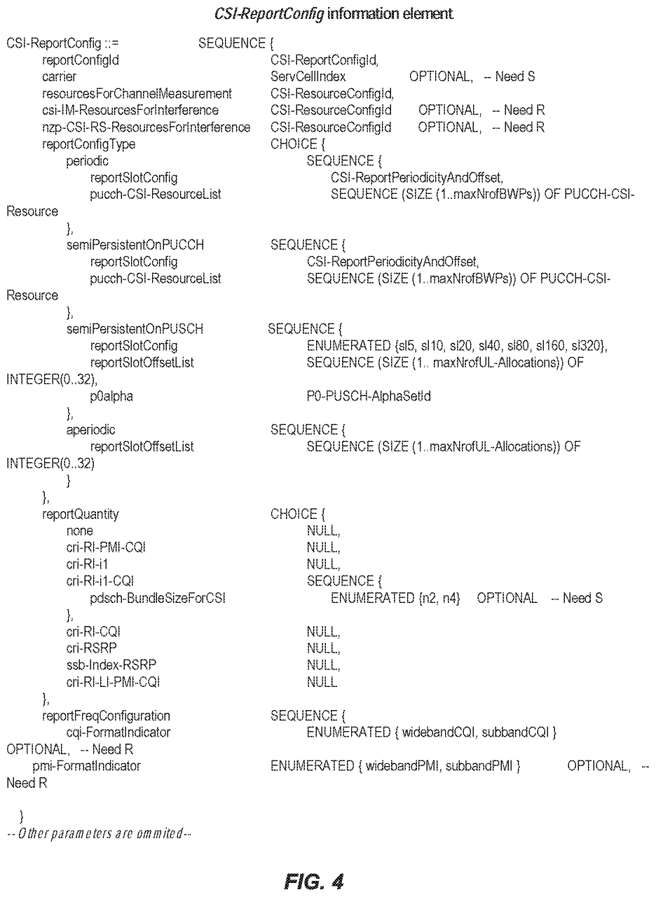

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be defined as part of the gNB transmitting and receiving radio signals to/from UE according to physical layer properties and parameters inherent to that element. In some embodiments, in Multiple Transmit/Receive Point (multi-TRP) operation, a serving cell can schedule UE from two TRPs, providing better PDSCH coverage, reliability and/or data rates. There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

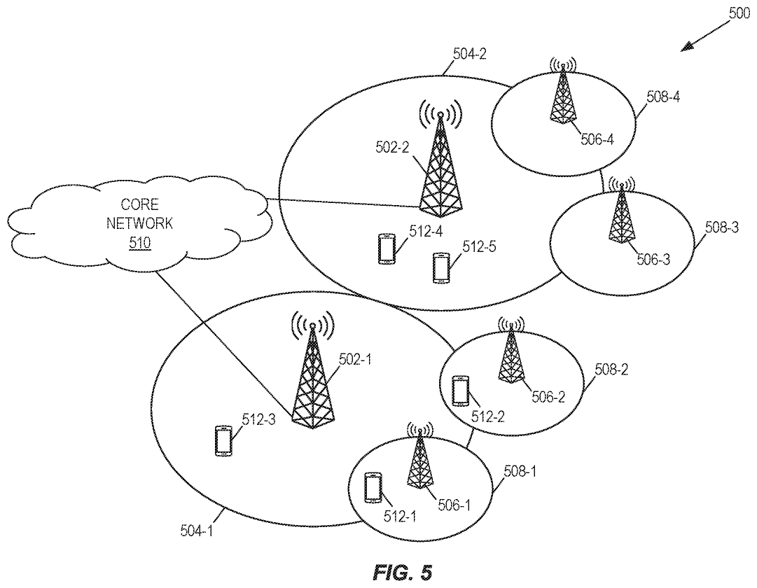

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC); however, the present disclosure is not limited thereto. Embodiments of the present disclosure may be utilized in other types of wireless communication systems such as, for example, an Evolved Packet System (EPS) including an Evolved Universal Terrestrial RAN (E-UTRAN) and an Evolved Packet Core (EPC). In this example, the RAN includes base stations 502-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs 512, but the present disclosure is not limited thereto.

There currently exist certain challenges. In NR Rel-15, a UE can be configured in a single CSI reporting setting with multiple NZP CSI-RS resources for channel measurement in a NZP CSI-RS resource set and a same number of CSI-IM resources in a CSI-IM resource set for interference measurement. Each of the NZP CSI-RS resources is resource-wise associated with a CSI-IM resource by the ordering of the NZP CSI-RS resource and CSI-IM resource in the corresponding resource sets. The UE first selects a pair of NZP CSI-RS and CSI-IM resources and then computes CSI based on the selected NZP CSI-RS and CSI-IM.

The same CSI reporting setting has been proposed for CSI feedback for single DCI based NC-JT, where two or more NZP CSI-RS resources in a NZP CSI-RS resource set are configured for channel measurement and a same number of CSI-IM resources in a CSI-IM resource set for interference measurement. However, instead of selecting a pair of NZP CSI-RS and CSI-IM resources, both the NZP CSI-RS and the CSI-IM resources are used to jointly compute a NC-JT CSI, which comprises at least two (RI, PMI) pairs, each associated with a TRP, and a joint CQI for each codeword.

One issue is how the two or more CSI-IM resources are used for interference measurement in case of NC-JT CSI. They can represent different instances of the same interference or different interferences.

Another issue is whether CSI based on other hypothesis, e.g., single TRP transmission, should also be reported.

Systems and methods for Channel State Information (CSI) feedback are provided. In some embodiments, a method performed by a User Equipment (UE) for CSI feedback for Non-Coherent Joint Transmission (NC-JT) Physical Downlink Shared Channel (PDSCH) transmission from multiple Transmission/Reception Points (TRPs) includes: receiving, from a network node, a CSI reporting setting comprising: a set of Non-Zero Power (NZP) CSI Reference Signal (CSI-RS) resources for channel measurement, the set of NZP CSI-RS resources for channel measurement comprising a first NZP CSI-RS resource for channel measurement and a second NZP CSI-RS resource for channel measurement; and a set of CSI for Interference Measurement (CSI-IM) resources comprising a first CSI-IM resource for interference measurement and a second CSI-IM resource for interference measurement; measuring interferences based on the set of CSI-IM resources, where the interferences are considered different instances of a same interference if a same set of receive antennas are used for receiving a PDSCH from multiple TRPs, and the interferences are considered different interferences if different sets of receive antennas are used for receiving the PDSCH from the multiple TRPs; and computing and reporting CSI feedback comprising: a NC-JT CSI and a first single TRP CSI; or a NC-JT CSI; or a CRI and a second single TRP CSI.

Embodiments of the proposed solutions define how interference should be measured on one or more CSI-IM resources for a UE computing NC-JT CSI. Embodiments of the proposed solutions may reduce CSI feedback overhead. Embodiments of the proposed solutions may improve scheduling flexibility by including multiple CSI hypothesis in the CSI report while keeping the reporting overhead low at the same time.

Now, a description of various embodiments of the present disclosure.

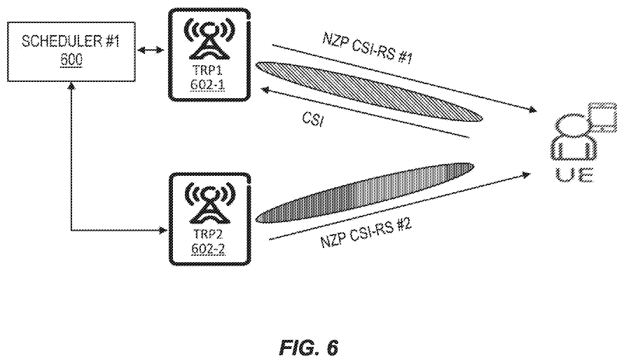

In single DCI based NC-JT, a single centralized scheduler 600 is used to schedule PDSCH transmissions from two TRPs 602-1 and 602-2 as shown in FIG. 6, where the CSI can be sent to one of the TRPs, e.g., the TRP 602-1 in the illustrated example. Note that TRP may not be explicitly specified in 3GPP specifications. Instead, a TRP may be represented by either a TCI state (e.g., uplink TCI state ID) or a spatial relation (e.g., a spatial relation ID). The CSI reported to one of the TRPs 602-1 may be sent via the following means:
on a PUCCH resource using Tx spatial filtering configuration associated with a TCI state or spatial relation which represents the TRP to which the CSI is to be sent, or
on a PUSCH resource using Tx spatial filtering configuration associated with a TCI state or spatial relation which represents the TRP to which the CSI is to be sent.

In this embodiment, the UE 512 is configured with one CSI reporting setting, where the CSI reporting setting comprises a NZP CSI-RS resource set for channel measurement (also referred to herein as a Channel Measurement Resource (CMR) set) that contains at least two NZP CSI-RS resources, each associated with one of two TRPs 602-1 and 602-2 as shown in FIG. 6. If the NZP CSI-RS resource set for channel measurement contains M>2 NZP CSI-RS resources, then each of the M NZP CSI-RS resources may correspond to one of M different TRPs. As part of the CSI report, the UE 512 may select two out of the M NZP CSI-RS resources (e.g., 2 out of the M TRPs) by indicating two different CRIs as part of the CSI report which represents the two selected TRPs. The CSI reporting setting also contains a CSI-IM resource set for interference measurement, wherein the CSI-IM resource set contains the same number of CSI-IM resources as the NZP CSI-RS resources in some embodiments. For example, the CSI reporting setting (i.e., the CSI report configuration) may contain the following:
CMR: {NZP CSI-RS #1, NZP CSI-RS #2} (also referred to herein as the NZP CSI-RS resource set for channel measurement); and
CSI-IM: {CSI-IM #1, CSI-IM #2}.

The CSI report type included in the CSI reporting setting can be either periodic, semi-persistent, or aperiodic. The CMR resource set can be periodic, semi-persistent, or aperiodic.

A new reporting quantity may be introduced to differentiate from the NR Rel-15 single TRP CSI reporting with multiple NZP CSI-RS and multiple CSI-IM resources. For example, the CSI reporting setting may configure a reporting quantity that corresponds to CSI reporting for multiple NZP CSI-RS resources and multiple CSI-IM resources.

In some other embodiments, in NR frequency range 1 (e.g., carrier frequencies in the sub-6 GHz frequency bands), the UE 512 may use a broad receive beam to receive the signals from the two NZP CSI-RS resources for channel measurement from the two TRPs 602-1 and 602-2. In this case, the TCI states associated with the two NZP CSI-RS resources for channel measurement from the two TRPs 602-1 and 602-2 may not contain a QCL source RS of QCL-Type D. In this case, the UE 512 may be only configured with a single CSI-IM resource as the interference can be measured using the broad receive beam by the UE 512. Alternatively, if two CSI-IM resources are configured, the UE 512 may average the interference measured in the two CSI-IM resources since the two CSI-IM resources are measured using the same broad receive beam by the UE 512.

In some other embodiments, in NR frequency range 2 (e.g., carrier frequencies in the frequency bands from 24.25 GHz to 52.6 GHz), the UE 512 may be equipped with two different UE antenna panels which it may use to receive the signals from the two NZP CSI-RS resources for channel measurement from the two TRPs 602-1 and 602-2 (each UE antenna panel used to receive from a respective TRP, e.g., if there are 2 antenna panels and 2 TRPs, one antenna panel will receive the first TRP and the other antenna panel will receive the second TRP). In this case, the UE 512 may use two different receive beams each associated with a different UE antenna panel. In this case, the TCI states associated with the two NZP CSI-RS resources for channel measurement from the two TRPs 602-1 and 602-2 will contain different QCL source RSs of QCL-Type D. Here, the UE 512 may be configured with two CSI-IM resources such that the interference measured on each UE antenna panel is measured on a different CSI-IM resource. That is, the interference corresponding to NZP CSI-RS #1 in FIG. 6 is measured using the first CSI-IM resource, and the interference corresponding to NZP CSI-RS #2 in FIG. 6 is measured using the second CSI-IM resource.

In some other embodiments, in NR frequency range 2 (e.g., carrier frequencies in the frequency bands from 24.25 GHz to 52.6 GHz), the UE 512 may be equipped with only a single UE antenna panel which it may use to receive the signals from both the two NZP CSI-RS resources for channel measurement from the two TRPs 602-1 and 602-2 (i.e., the single UE antenna panel is used to receive signals from both TRPs 602-1 and 602-2). In this case, the UE 512 may use a single receive beam associated with the single UE antenna panel. Here, the UE 512 may be only configured with a single CSI-IM resource as the interference can be measured using the single receive beam by the UE 512. Alternatively, if two CSI-IM resources are configured, the UE 512 may average the interference measured in the two CSI-IM resources since the two CSI-IM resources are measured using the same receive beam by the UE 512.

### NC-JT CSI Computation

The UE 512 may assume that the CSI corresponds to NC-JT transmission in which the UE 512 receives a first set of PDSCH layers (with corresponding first set of PDSCH DM-RS ports) from a first TRP (e.g., TRP 602-1) and a second set of PDSCH layers (with corresponding second set of PDSCH DM-RS ports) from a second TRP (e.g., TRP 602-2), wherein the first and the second sets of PDSCH layers are fully overlapped in time and frequency domain. The first TRP is associated with NZP CSI-RS #1, and the second TRP is associated with NZP CSI-RS #2. The NC-JT CSI may contain a first RI and a first PMI associated with the first TRP, as well as a second RI and a second PMI associated with the second TRP. If the total number of PDSCH layers across the two TRPs is less than or equal to 4, then the NC-JT CSI will contain a single CQI (e.g., single wideband CQI and possibly additional corresponding subband CQIs). If the total number of PDSCH layers across the two TRPs is more than 4, then the NC-JT CSI will contain two CQIs (e.g., two wideband CQIs and possibly additional corresponding subband CQIs). The two CQIs in the latter case corresponds to two codewords transmitted in the NC-JT transmission over the two TRPs. In summary, the NC-JT CSI contents are as follows:

NC-JT CSI:
{RI #1, PMI #1} associated with NZP CSI-RS #1,
{RI #2, PMI #2} associated with NZP CSI-RS #2,
CQI #1 when the number of PDSCH layers across the two TRPs is less than or equal to 4,
CQI #1 and CQI #2 when the number of PDSCH layers across the two TRPs is more than 4.
   where RI#1+RI#2<=the total number of Rx antenna ports at the UE 512.

For interference measurement on CSI-IM, the UE 512 assumes that the NZP CSI-RS resource(s) for channel measurement and the CSI-IM resource(s) for interference measurement configured for the CSI reporting are resource-wise QCLed with respect to ‘QCL-TypeD’ if configured.

If the same Rx antennas are used to receive a PDSCH from two TRPs, typically in case of frequency range 1 (FR1), the UE 512 received signal y ∈ C^{M×1} can be expressed as

y=H₁W₁s₁+H₂W₂s₂+n

where H₁ ∈ C^{M×N}^{₁} and H₂ ∈ C^{M×N}^{₂} are the channel matrix associated with TRP1 and TRP2, respectively; W₁ ∈ C^{N}^{₁}^{×r}^{₁} and W₂ ∈ C^{N}^{₂}^{×r}^{₂} are the precoding matrices applied in TRP1 and TRP2, respectively; s₁ ∈ C^{r}^{₁}^{×1} and s₂ ∈ C^{r}^{₂}^{×1} are the data symbols transmitted from TRP1 and TRP2, respectively; n ∈ C^{M×1} is the receive noise and interference from other cells; N₁ and N₂ are the number of transmit antennas at TRP1 and TRP2, respectively; M is the number of UE receive antennas; r₁ and r₂ are the number of MIMO layers from TRP1 and TRP2, respectively. In this case, interference measured on the two CSI-IM resources represents two observations of n, and thus the interference is averaged.

Thus, in another embodiment, if QCL-type D is not configured for NZP CSI-RS #1 and NZP CSI-RS #2, a single CSI-IM may be configured in the CSI reporting setting.

On the other hand, if two different groups of Rx antennas, e.g., two Rx antenna panels typically in in frequency range 1 (FR2), are used to receive a PDSCH from two TRPs, respectively, the UE 512 received signal y ∈ C^{m×1} can be expressed as

$$y = [ \begin{matrix}{y}_{1} \\ {y}_{2}\end{matrix} ] = [ \begin{matrix}{H}_{11} & {H}_{12} \\ {H}_{21} & {H}_{22}\end{matrix} ] [ \begin{matrix}{W}_{1} {s}_{1} \\ {W}_{2} {s}_{2}\end{matrix} ] + [ \begin{matrix}{n}_{1} \\ {n}_{2}\end{matrix} ]$$

where y₁ ∈ C^{M}^{₁}^{×1} and y₂ ∈ C^{M}^{₂}^{×1} are the signals received on a first and a second antenna panels, respectively; H₁₁ ∈ C^{M}^{₁}^{N}^{₁} and H₂₂ ∈ C^{M}^{₂}^{×N}^{₂} are the channel matrices associated with (TRP1, Rx panel #1) and (TRP2, Rx panel #2), respectively; H₁₂ ∈ C^{M}^{₁}^{×N}^{₂} and H₂₁ ∈ C^{M}^{₂}^{×N}^{₁} are the cross over channel matrices associated with (TRP2, Rx panel #1) and (TRP1,Rx panel #2), respectively; W₁ ∈ C^{N}^{₁}^{×r}^{₁} and W₂ ∈ C^{N}^{₂}^{×r}^{₂} are the precoding matrices applied in TRP1 and TRP2, respectively; s₁ ∈ C^{r}^{₁}^{×1} and s₂ ∈ C^{r}^{₂}^{×1} are the data symbols transmitted from TRP1 and TRP2, respectively; n₁ ∈ C^{M}^{₁}^{×1} and n₂ ∈ C^{M}^{₂}^{×1} are the received noise and interference on the first and the second groups of antenna ports; N₁ and N₂ are the number of transmit antennas at TRP1 and TRP2, respectively; M₁ and M₂ (M=M₁+M₂) are the number of UE receive antennas in the first and the second antenna group or panel; r₁ and r₂ are the number of MIMO layers from TRP1 and TRP2, respectively. In this case, interference measured on each of the two CSI-IM resources represents interference observed with each of the two antenna panels, i.e., n₁ and n₂ are measured on CSI-IM #1 and CSI-IM#2, respectively.

Thus, in another embodiment, if QCL-type D is configured for NZP CSI-RS #1 and NZP CSI-RS #2, two CSI-IM resources need to be configured in the CSI reporting setting. Depending on whether the UE 512 is using a single Rx panel or two Rx panels for DL reception, the UE 512 may measure interference and noise differently based on the CSI-IM resources.

### Reporting NC-JT CSI Plus Signal TRP CSI

In addition to NC-JT CSI described above, single TRP CSI may also be reported together with the NC-JT CSI to facilitate dynamic scheduling between single TRP and NC-JT transmissions. Two single TRP CSIs are preferred as it allows more flexible scheduling. Each single TRP CSI may contain a RI, a PMI, and a CQI. Thus, in one embodiment, the CSI report contains:
NC-JT CSI:
   {RI #1, PMI #1} associated with NZP CSI-RS #1,
   {RI #2, PMI #2} associated with NZP CSI-RS #2, and
   CQI #1 when the number of layers <=4,
   CQI #1 and CQI #2 when the number of layers is >4
Single TRP CSI:
   {RI#3, PMI#3, CQI#3} associated with NZP CSI-RS #1
   {RI#4, PMI#4, CQI#4} associated with NZP CSI-RS #2

In some cases, there may be more than two NZP CSI-RS resources configured in the NZP CSI-RS resource set for channel measurement. In this case, the NC-JT CSI may also contain the CRI where one CRI is fed back per TRP (i.e., CRI #1 corresponding to TRP 1 and CRI #2 corresponding to TRP 2). In addition, the single TRP CSI may also contain a CRI. An example is shown below:
NC-JT CSI:
   {CRI #1, RI #1, PMI #1} associated with NZP CSI-RS #1,
   {CRI #2, RI #2, PMI #2} associated with NZP CSI-RS #2, and
   CQI #1 when the number of layers <=4,
   CQI #1 and CQI #2 when the number of layers is >4
Single TRP CSI:
   {CRI #1, RI#3, PMI#3, CQI#3} associated with NZP CSI-RS #1
   {CRI #2, RI#4, PMI#4, CQI#4} associated with NZP CSI-RS #2

In some cases, only one single TRP CSI may be reported along with NC-JT CSI. In these cases, the CSI report may be given by the following example:
NC-JT CSI:
   {CRI #1, RI #1, PMI #1} associated with NZP CSI-RS #1,
   {CRI #2, RI #2, PMI #2} associated with NZP CSI-RS #2, and
   CQI #1 when the number of layers <=4,
   CQI #1 and CQI #2 when the number of layers is >4
Single TRP CSI:
   {CRI #2, RI#3, PMI#3, CQI#3} associated with NZP CSI-RS #2

Note that in the example above single TRP CSI corresponds to NZP CSI-RS #2 (i.e., TRP #2), and the NC-JT CSI corresponds to NZP CSI-RSs #1 and #2 (i.e., TRP #1 and TRP #2). In some embodiments, the single TRP CSI may correspond to a different TRP than the TRPs involved in the NC-JT CSI. For instance, the NC-JT CSI corresponds to NZP CSI-RSs #1 and #2 (i.e., TRP #1 and TRP #2), while the single TRP CSI may correspond to NZP CSI-RS #3 (i.e., TRP #3). The CSI report in this case may be given by the following example:
NC-JT CSI:
   {CRI #1, RI #1, PMI #1} associated with NZP CSI-RS #1,
   {CRI #2, RI #2, PMI #2} associated with NZP CSI-RS #2, and
   CQI #1 when the number of layers <=4,
   CQI #1 and CQI #2 when the number of layers is >4
Single TRP CSI:
   {CRI #3, RI#3, PMI#3, CQI#3} associated with NZP CSI-RS #3

### Sharing RIs and PMIs in NC-JT CSI with Single TRP CSI

In another embodiment, RI#1 and PMI#1 reported for NC-JT may be assumed in calculating CQI#3 for single TRP transmission from TRP #1. Similarly, RI#2 and PMI#2 may be assumed in calculating CQI#4 for single TRP transmission from TRP #2. In this case, RI#3, PMI#3, RI#4, and PMI#4 are not reported, and feedback overhead is thus reduced. The CSI report would contain:
NC-JT CSI:
   {RI #1, PMI #1} associated with NZP CSI-RS #1,
   {RI #2, PMI #2} associated with NZP CSI-RS #2,
   CQI #1 when the number of layers <=4,
   CQI #1 and CQI #2 when the number of layers is >4
Single TRP CSI:
   {CQI#3} associated with NZP CSI-RS #1
   {CQI#4} associated with NZP CSI-RS #2

In some cases, only one single TRP CSI may be reported along with NC-JT CSI. For instance, if single TRP CSI corresponding to TRP #2 is included as part of the CSI report, then RI#2 and PMI#2 may be assumed in calculating CQI#3 for single TRP transmission from TRP #2. In these cases, the CSI report may be given by the following example:
NC-JT CSI:
   {CRI #1, RI #1, PMI #1} associated with NZP CSI-RS #1,
   {CRI #2, RI #2, PMI #2} associated with NZP CSI-RS #2, and
   CQI #1 when the number of layers <=4,
   CQI #1 and CQI #2 when the number of layers is >4
Single TRP CSI:
   {CRI #2, CQI#3} associated with NZP CSI-RS #2

Note that which RI and PMI should be assumed for the single TRP CSI in the above example is given by the CRI. Since the single TRP CSI includes a CRI, the corresponding RI and PMI from the NC-JT CSI with the same CRI are assumed to be used for the single TRP CSI. For instance, CRI #2 is reported in the single TRP CSI, and the corresponding RI and PMI for the single TRP CSI are those associated with CRI #2 in the NC-JT CSI (i.e., RI #2 and PMI #2).

In case that there are only two NZP CSI-RS resources are configured, the CRI#1 and CRI#2 in the NC-JT CSI may not be reported.

### Omitting NC-JT CSI Under Certain Conditions

NC-JT may not always provide better performance than single TRP transmission. Thus, in another embodiment NC-JT CSI may be dropped from the CSI report under certain conditions.

In one example, if any one of the single TRP CSI provides higher throughput than by the NC-JT CSI, the NC-JT CSI is omitted and only the single TRP CSI with higher throughput is reported.

The CSI report may contain a CRI with
CRI=0 indicating a single TRP CSI associated with the first NZP CSI-RS resource, i.e., CSI includes: CRI=0, RI#3, PMI#3, CQI #3
CRI=1 indicating a single TRP CSI associated with the second NZP CSI-RS resource, i.e., CSI includes: CRI=1, RI#4, PMI#4, CQI #4
CRI=2 indicating NC-JT CSI, i.e., CRI=2, RI #1, PMI #1, CQI #1, RI #2, PMI #2, CQI #2

In another example, the UE 512 may decide whether it should report one of the following:
one or two single TRP CSIs,
one NC-JT CSI,
one single TRP CSI+one NC-JT CSI, or
two single TRP CSIs+one NC-JT CSI.

The choice of which hypotheses the UE 512 should report is decided by the UE 512 based on a metric (such as hypothetical throughput) associated with each hypothesis. As part of the CSI report, the UE 512 may include an indicator that indicates which one of the hypotheses the UE 512 is reporting.

### Further Description

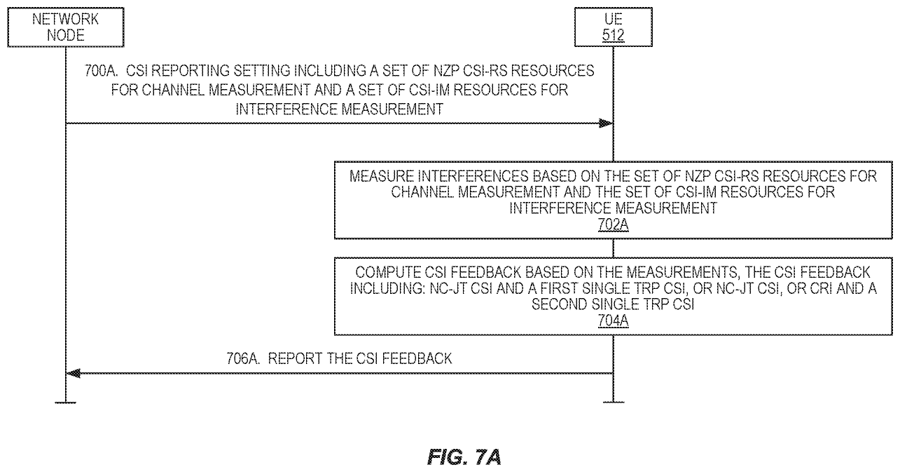

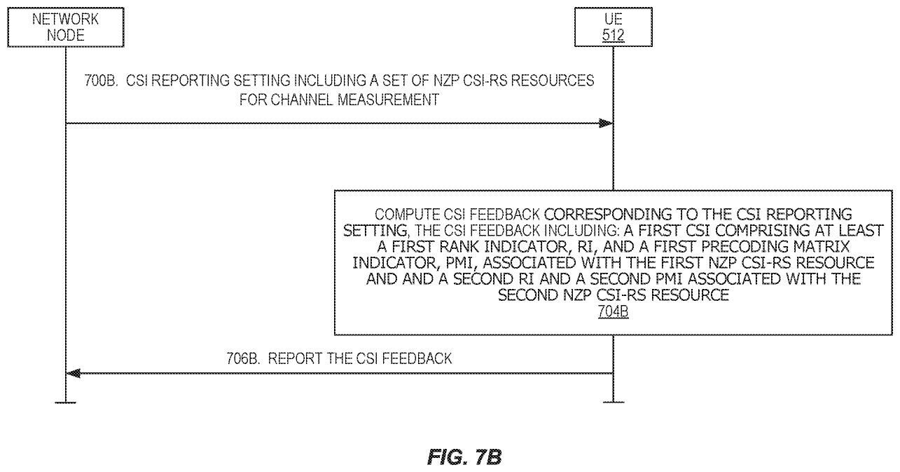

FIG. 7A illustrates the operation of a network node (e.g., a base station 502 or network node corresponding to TRP#1 or TRP 602-1 described above) and a UE 512 for CSI feedback for single DCI based NC-JT in accordance with at least some of the embodiments described above. It should be noted that while some details described above are repeated here or further elaborated on with respect to FIG. 7A, all of the details provided above in relation to the CSI reporting setting, the measurement of interferences, and the CSI computation and reporting are equally applicable here to the process of FIG. 7A.

As illustrated, the network node sends to the UE 512 (and the UE 512 receives) a CSI reporting setting comprising a NZP CSI-RS resource set for channel measurement (i.e., a CMR set) and a CSI-IM resource set, as described above (step 700A). The NZP CSI-RS resource set includes at least two NZP CSI-RS resources, each associated with one of the TRPs (e.g., one of the TRPs 602-1 and 602-2). Note that, in one embodiment, if the NZP CSI-RS resource set for channel measurement contains M>2 NZP CSI-RS resources for channel measurement, then each of the M NZP CSI-RS resources may correspond to one of M different TRPs. As part of the CSI report, the UE 512 may select two out of the M NZP CSI-RS resources (e.g., 2 out of the M TRPs) by indicating two different CRIs as part of the CSI report which represents the two selected TRPs. The CSI-IM resource set for interference measurement contains the same number of CSI-IM resources as the NZP CSI-RS resources in some embodiments. In one embodiment, the NZP CSI-RS resource set includes a first NZP CSI-RS resource for channel measurement and a second NZP CSI-RS resource for channel measurement, and the CSI-IM resource set includes a first CSI-IM resource and a second CSI-IM resource. Thus, for example, the CSI reporting setting (i.e., the CSI report configuration) may contain the following:
CMR: {NZP CSI-RS #1, NZP CSI-RS #2} (also referred to herein as the NZP CSI-RS resource set for channel measurement); and
CSI-IM: {CSI-IM #1, CSI-IM #2}.

In one embodiment, the CSI reporting setting also includes a report quantity identifier that indicates that a NC-JT CSI report is to be sent.

The UE 512 measures interferences based on the CSI reporting setting and, in particular, based on the NZP CSI-RS resource set for channel measurement and the CSI-IM resource set for interference measurement (step 702A). Using the measurements, the UE 512 computes and reports (steps 704A and 706A) CSI feedback, the CSI feedback comprising: (a) a NC-JT CSI and a first single TRP CSI, (b) NC-JT CSI, or (c) a CRI and a second single TRP CSI, as described above.

FIG. 7B illustrates the operation of a network node (e.g., a base station 502 or network node corresponding to TRP#1 or TRP 602-1 described above) and a UE 512 for CSI feedback in accordance with at least some of the embodiments described above. In some embodiments, the UE receives (step 700B), from a network node, a CSI reporting setting comprising: a set of NZP CSI-RS resources for channel measurement, the set of NZP CSI-RS resources for channel measurement includes a first NZP CSI-RS resource for channel measurement, a second NZP CSI-RS resource for channel measurement, a third NZP CSI-RS resource for channel measurement, and a fourth NZP CSI-RS for channel measurement. The method also includes computing and reporting (steps 704B-706B) CSI feedback corresponding to the CSI reporting setting including: a first CSI including at least a first RI and a first PMI associated with the first NZP CSI-RS resource for channel measurement, and a second RI and a second PMI associated with the second NZP CSI-RS resource for channel measurement; and at least one of a second CSI and a third CSI. In some embodiments, the second CSI includes at least a third RI and a third PMI associated with the third NZP CSI-RS resource for channel measurement, and the third CSI includes at least a fourth RI and a fourth PMI associated with the fourth NZP CSI-RS resource for channel measurement.

Continuing the example above in which the NZP CSI-RS resource set includes a first NZP CSI-RS resource for channel measurement and a second NZP CSI-RS resource for channel measurement and the CSI-IM resource set includes a first CSI-IM resource and a second CSI-IM resource, the UE 512 measurements interferences based on the first CSI-IM resource and the second CSI-IM resource where the interferences are considered different instances of a same interference if a same set of receive antennas are used for receiving a PDSCH from the two (or more) TRPs, and the interferences are considered different interferences if different sets of receive antennas are used for receiving the PDSCH from the TRPs. In one embodiment, the first CSI-IM resource is for measuring interference received on a first set of antenna ports for receiving the PDSCH from a first TRP associated with the first NZP CSI-RS resource, while the second CSI-IM is for measuring interference received on a second set of antenna ports for receiving the PDSCH from a second TRP associated with the second NZP CSI-RS resource.

In one embodiment, the NC-JT CSI comprises a first RI and a second RI, a first PMI and a second PMI, and a first CQI and in some cases a second CQI. In one embodiment, the NC-JT CSI may further comprise a first CRI and/or a second CRI.

In one embodiment, the first single TRP CSI comprises a third RI, a third PMI, and a third CQI based on the first NZP CSI-RS resource and the first CSI-IM resource. In one embodiment, the UE may assume that the third RI equals to the first RI, and the third PMI equals to the first PMI, wherein the third RI and PMI are not reported. In one embodiment, the first single TRP CSI may further comprise a fourth RI, a fourth PMI, and a fourth CQI based on the second NZP CSI-RS resource and the second CSI-IM resource. In one embodiment, the UE may assume that the fourth RI equals to the second RI, and the fourth PMI equals to the second PMI, wherein the fourth RI and PMI are not reported. In one embodiment, the first single TRP CSI may further comprises a first and/or a second CRI.

In one embodiment, the second single TRP CSI comprises the third RI, the third PMI, and the third CQI if CRI=0, and the fourth RI, the fourth PMI, and the fourth CQI if CRI=1.

FIG. 8 is a schematic block diagram of a network node 800 according to some embodiments of the present disclosure. Optional features are represented by dashed boxes. The network node 800 may be, for example, a base station 502 or 506 or a network node that implements all or part of the functionality of the base station 502 or gNB described herein. As illustrated, the network node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, if the network node 800 is a radio access node (e.g., a base station 502), the network node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of the network node 800 as described herein (e.g., one or more functions of a network node such as, e.g., the network node of FIGS. 7A and/or 7B, as described herein). In some embodiments, the function(s) are implemented in software that is stored, e.g., in the memory 806 and executed by the one or more processors 804.

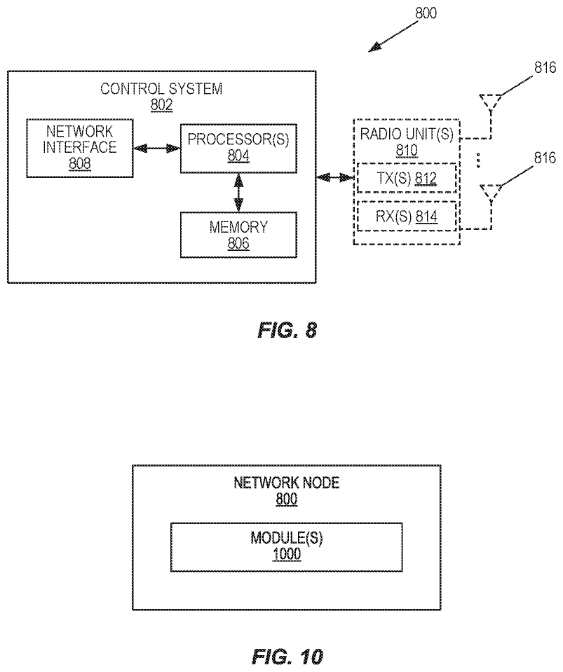

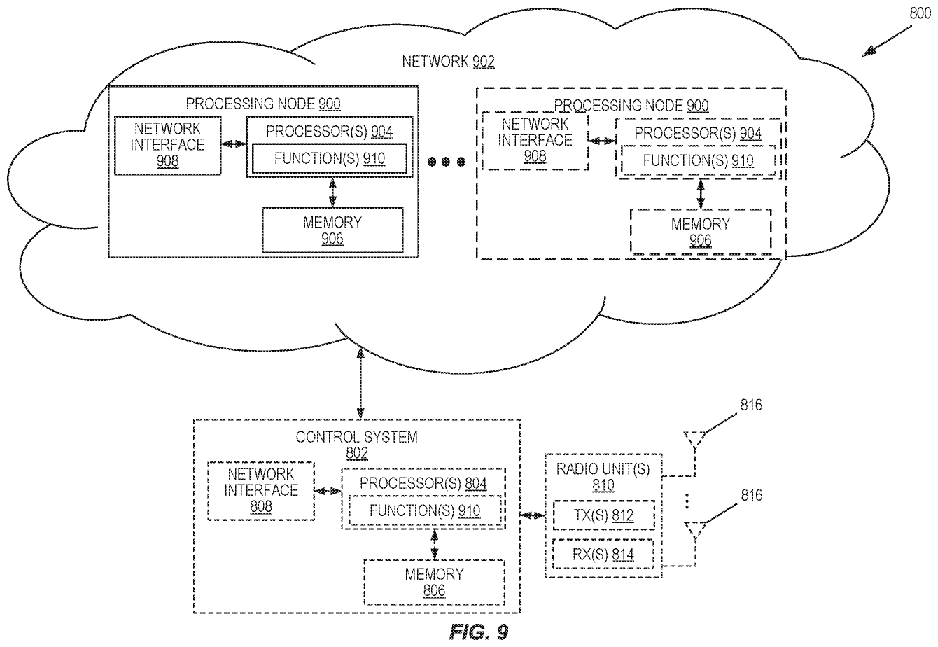

FIG. 9 is a schematic block diagram that illustrates a virtualized embodiment of the network node 800 according to some embodiments of the present disclosure. Again, optional features are represented by dashed boxes. As used herein, a “virtualized” radio access node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902. Each processing node 900 includes one or more processors 904 (e.g., CPUs, ASICs, FPGAs, and/or the like), memory 906, and a network interface 908. If the network node 800 is a radio access node (e.g., a base station 502), the network node 800 may include the control system 802 and/or the one or more radio units 810, as described above. The control system 802 may be connected to the radio unit(s) 810 via, for example, an optical cable or the like. If present, the control system 802 or the radio unit(s) are connected to the processing node(s) 900 via the network 902.

In this example, functions 910 of the network node 800 described herein (e.g., one or more functions of a network node such as, e.g., the network node of FIGS. 7A and 7B, as described herein) are implemented at the one or more processing nodes 900 or distributed across the one or more processing nodes 900 and the control system 802 and/or the radio unit(s) 810 in any desired manner. In some particular embodiments, some or all of the functions 910 of the network node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

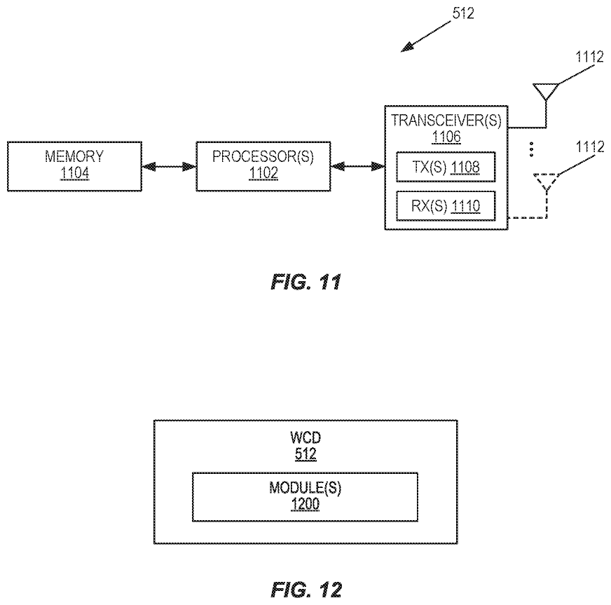

FIG. 11 is a schematic block diagram of the wireless communication device 512 (or UE 512) according to some embodiments of the present disclosure. As illustrated, the wireless communication device 512 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 512 described above may be fully or partially implemented in software that is, e.g., stored in the memory 1104 and executed by the processor(s) 1102. Note that the wireless communication device 512 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 512 and/or allowing output of information from the wireless communication device 512), a power supply (e.g., a battery and associated power circuitry), etc.

In some embodiments, a computer program including instructions which, when executed by at least one processor, causes the at least one processor to carry out the functionality of the wireless communication device 512 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the wireless communication device 512 according to some other embodiments of the present disclosure. The wireless communication device 512 includes one or more modules 1200, each of which is implemented in software. The module(s) 1200 provide the functionality of the wireless communication device 512 described herein.

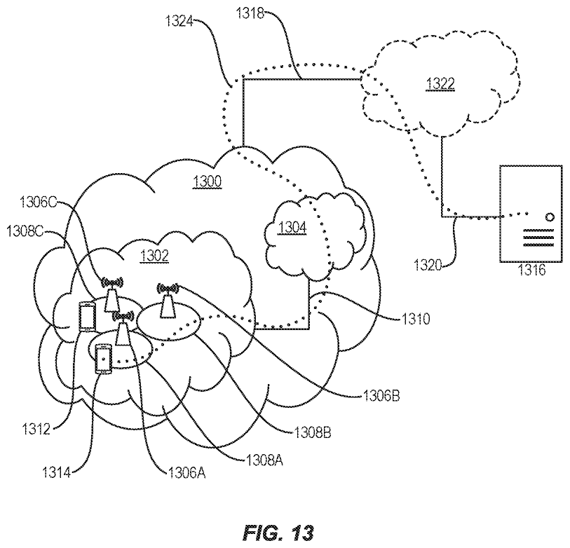

With reference to FIG. 13, in accordance with an embodiment, a communication system includes a telecommunication network 1300, such as a 3GPP-type cellular network, which comprises an access network 1302, such as a RAN, and a core network 1304. The access network 1302 comprises a plurality of base stations 1306A, 1306B, 1306C, such as Node Bs, eNBs, gNBs, or other types of wireless Access Points (APs), each defining a corresponding coverage area 1308A, 1308B, 1308C. Each base station 1306A, 1306B, 1306C is connectable to the core network 1304 over a wired or wireless connection 1310. A first UE 1312 located in coverage area 1308C is configured to wirelessly connect to, or be paged by, the corresponding base station 1306C. A second UE 1314 in coverage area 1308A is wirelessly connectable to the corresponding base station 1306A. While a plurality of UEs 1312, 1314 are illustrated in this example, the disclosed embodiments are equally applicable to a situation where a sole UE is in the coverage area or where a sole UE is connecting to the corresponding base station 1306.

The telecommunication network 1300 is itself connected to a host computer 1316, which may be embodied in the hardware and/or software of a standalone server, a cloud-implemented server, a distributed server, or as processing resources in a server farm. The host computer 1316 may be under the ownership or control of a service provider, or may be operated by the service provider or on behalf of the service provider. Connections 1318 and 1320 between the telecommunication network 1300 and the host computer 1316 may extend directly from the core network 1304 to the host computer 1316 or may go via an optional intermediate network 1322. The intermediate network 1322 may be one of, or a combination of more than one of, a public, private, or hosted network; the intermediate network 1322, if any, may be a backbone network or the Internet; in particular, the intermediate network 1322 may comprise two or more sub-networks (not shown).

The communication system of FIG. 13 as a whole enables connectivity between the connected UEs 1312, 1314 and the host computer 1316. The connectivity may be described as an Over-the-Top (OTT) connection 1324. The host computer 1316 and the connected UEs 1312, 1314 are configured to communicate data and/or signaling via the OTT connection 1324, using the access network 1302, the core network 1304, any intermediate network 1322, and possible further infrastructure (not shown) as intermediaries. The OTT connection 1324 may be transparent in the sense that the participating communication devices through which the OTT connection 1324 passes are unaware of routing of uplink and downlink communications. For example, the base station 1306 may not or need not be informed about the past routing of an incoming downlink communication with data originating from the host computer 1316 to be forwarded (e.g., handed over) to a connected UE 1312. Similarly, the base station 1306 need not be aware of the future routing of an outgoing uplink communication originating from the UE 1312 towards the host computer 1316.

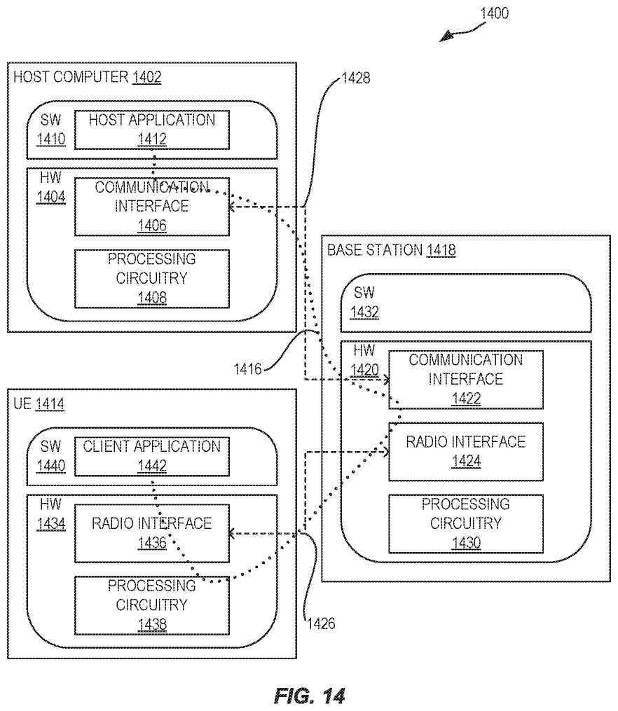

Example implementations, in accordance with an embodiment, of the UE, base station, and host computer discussed in the preceding paragraphs will now be described with reference to FIG. 14. In a communication system 1400, a host computer 1402 comprises hardware 1404 including a communication interface 1406 configured to set up and maintain a wired or wireless connection with an interface of a different communication device of the communication system 1400. The host computer 1402 further comprises processing circuitry 1408, which may have storage and/or processing capabilities. In particular, the processing circuitry 1408 may comprise one or more programmable processors, ASICs, FPGAs, or combinations of these (not shown) adapted to execute instructions. The host computer 1402 further comprises software 1410, which is stored in or accessible by the host computer 1402 and executable by the processing circuitry 1408. The software 1410 includes a host application 1412. The host application 1412 may be operable to provide a service to a remote user, such as a UE 1414 connecting via an OTT connection 1416 terminating at the UE 1414 and the host computer 1402. In providing the service to the remote user, the host application 1412 may provide user data which is transmitted using the OTT connection 1416.

The communication system 1400 further includes a base station 1418 provided in a telecommunication system and comprising hardware 1420 enabling it to communicate with the host computer 1402 and with the UE 1414. The hardware 1420 may include a communication interface 1422 for setting up and maintaining a wired or wireless connection with an interface of a different communication device of the communication system 1400, as well as a radio interface 1424 for setting up and maintaining at least a wireless connection 1426 with the UE 1414 located in a coverage area (not shown in FIG. 14) served by the base station 1418. The communication interface 1422 may be configured to facilitate a connection 1428 to the host computer 1402. The connection 1428 may be direct or it may pass through a core network (not shown in FIG. 14) of the telecommunication system and/or through one or more intermediate networks outside the telecommunication system. In the embodiment shown, the hardware 1420 of the base station 1418 further includes processing circuitry 1430, which may comprise one or more programmable processors, ASICs, FPGAs, or combinations of these (not shown) adapted to execute instructions. The base station 1418 further has software 1432 stored internally or accessible via an external connection.

The communication system 1400 further includes the UE 1414 already referred to. The UE's 1414 hardware 1434 may include a radio interface 1436 configured to set up and maintain a wireless connection 1426 with a base station serving a coverage area in which the UE 1414 is currently located. The hardware 1434 of the UE 1414 further includes processing circuitry 1438, which may comprise one or more programmable processors, ASICs, FPGAs, or combinations of these (not shown) adapted to execute instructions. The UE 1414 further comprises software 1440, which is stored in or accessible by the UE 1414 and executable by the processing circuitry 1438. The software 1440 includes a client application 1442. The client application 1442 may be operable to provide a service to a human or non-human user via the UE 1414, with the support of the host computer 1402. In the host computer 1402, the executing host application 1412 may communicate with the executing client application 1442 via the OTT connection 1416 terminating at the UE 1414 and the host computer 1402. In providing the service to the user, the client application 1442 may receive request data from the host application 1412 and provide user data in response to the request data. The OTT connection 1416 may transfer both the request data and the user data. The client application 1442 may interact with the user to generate the user data that it provides.

It is noted that the host computer 1402, the base station 1418, and the UE 1414 illustrated in FIG. 14 may be similar or identical to the host computer 1316, one of the base stations 1306A, 1306B, 1306C, and one of the UEs 1312, 1314 of FIG. 13, respectively. This is to say, the inner workings of these entities may be as shown in FIG. 14 and independently, the surrounding network topology may be that of FIG. 13.

In FIG. 14, the OTT connection 1416 has been drawn abstractly to illustrate the communication between the host computer 1402 and the UE 1414 via the base station 1418 without explicit reference to any intermediary devices and the precise routing of messages via these devices. The network infrastructure may determine the routing, which may be configured to hide from the UE 1414 or from the service provider operating the host computer 1402, or both. While the OTT connection 1416 is active, the network infrastructure may further take decisions by which it dynamically changes the routing (e.g., on the basis of load balancing consideration or reconfiguration of the network).

The wireless connection 1426 between the UE 1414 and the base station 1418 is in accordance with the teachings of the embodiments described throughout this disclosure. One or more of the various embodiments improve the performance of OTT services provided to the UE 1414 using the OTT connection 1416, in which the wireless connection 1426 forms the last segment.

A measurement procedure may be provided for the purpose of monitoring data rate, latency, and other factors on which the one or more embodiments improve. There may further be an optional network functionality for reconfiguring the OTT connection 1416 between the host computer 1402 and the UE 1414, in response to variations in the measurement results. The measurement procedure and/or the network functionality for reconfiguring the OTT connection 1416 may be implemented in the software 1410 and the hardware 1404 of the host computer 1402 or in the software 1440 and the hardware 1434 of the UE 1414, or both. In some embodiments, sensors (not shown) may be deployed in or in association with communication devices through which the OTT connection 1416 passes; the sensors may participate in the measurement procedure by supplying values of the monitored quantities exemplified above, or supplying values of other physical quantities from which the software 1410, 1440 may compute or estimate the monitored quantities. The reconfiguring of the OTT connection 1416 may include message format, retransmission settings, preferred routing, etc.; the reconfiguring need not affect the base station 1418, and it may be unknown or imperceptible to the base station 1418. Such procedures and functionalities may be known and practiced in the art. In certain embodiments, measurements may involve proprietary UE signaling facilitating the host computer 1402's measurements of throughput, propagation times, latency, and the like. The measurements may be implemented in that the software 1410 and 1440 causes messages to be transmitted, in particular empty or ‘dummy’ messages, using the OTT connection 1416 while it monitors propagation times, errors, etc.

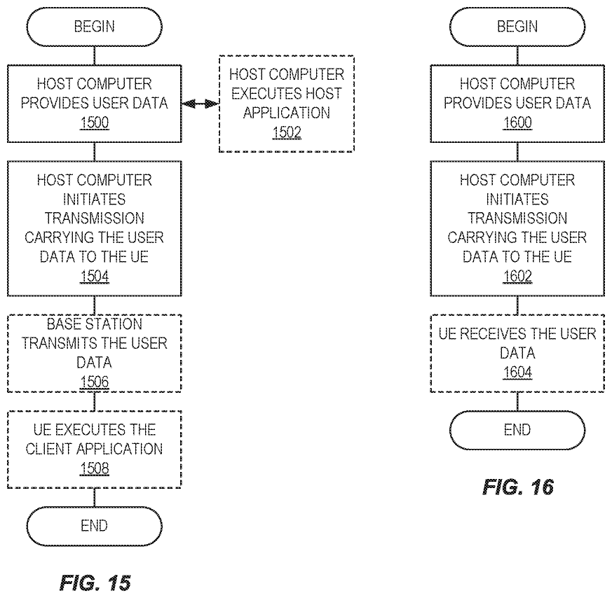

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1500, the host computer provides user data. In sub-step 1502 (which may be optional) of step 1500, the host computer provides the user data by executing a host application. In step 1504, the host computer initiates a transmission carrying the user data to the UE. In step 1506 (which may be optional), the base station transmits to the UE the user data which was carried in the transmission that the host computer initiated, in accordance with the teachings of the embodiments described throughout this disclosure. In step 1508 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1600 of the method, the host computer provides user data. In an optional sub-step (not shown) the host computer provides the user data by executing a host application. In step 1602, the host computer initiates a transmission carrying the user data to the UE. The transmission may pass via the base station, in accordance with the teachings of the embodiments described throughout this disclosure. In step 1604 (which may be optional), the UE receives the user data carried in the transmission.

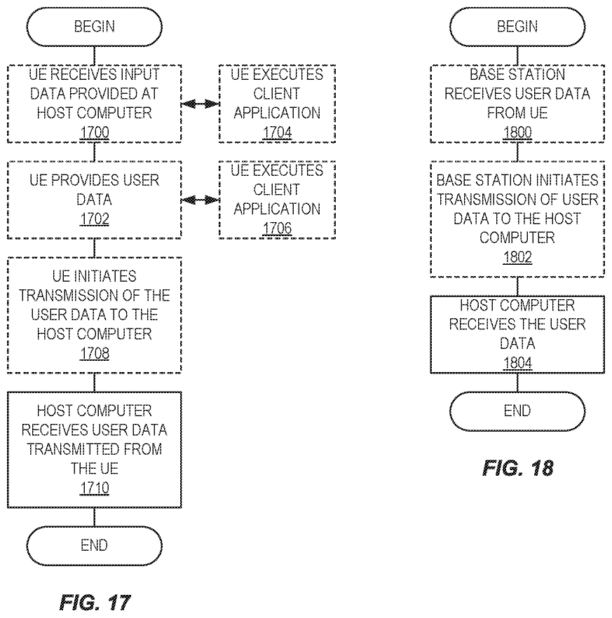

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a User Equipment, UE, (512) for Channel State Information, CSI, feedback for Non-Coherent Joint Transmission, NC-JT, Physical Downlink Shared Channel, PDSCH, transmission from multiple Transmission/Reception Points, TRPs, (602-1, 602-2), the method comprising one or more of the following: receiving (700), from a network node, a CSI reporting setting comprising: a set of Non-Zero Power, NZP, CSI Reference Signal, CSI-RS, resources for channel measurement, the set of NZP CSI-RS resources for channel measurement comprising a first NZP CSI-RS resource for channel measurement and a second NZP CSI-RS resource for channel measurement; and a set of CSI for Interference Measurement, CSI-IM, resources comprising a first CSI-IM resource for interference measurement and a second CSI-IM resource for interference measurement; measuring (702) interferences based on the set of CSI-IM resources, where the interferences are considered different instances of a same interference if a same set of receive antennas are used for receiving a PDSCH from multiple TRPs, and the interferences are considered different interferences if different sets of receive antennas are used for receiving the PDSCH from the multiple TRPs; and computing and reporting (steps 704-706) CSI feedback comprising: a NC-JT CSI and a first single TRP CSI, or a NC-JT CSI, or a CRI and a second single TRP CSI.

Embodiment 2: The method of embodiment 1 wherein the CSI reporting setting further comprises a report quantity identifier indicating a NC-JT CSI report.

Embodiment 3: The method of embodiment 1 or 2 wherein the multiple TRPs comprise a first TRP (602-1) and a second TRP (602-2), and measuring (702) the interferences comprises measuring (702) the interferences based on the first CSI-IM resource and the second CSI-IM resource where the interferences are considered different instances of a same interference if a same set of receive antennas are used for receiving the PDSCH from the first and second TRPs (602-1 and 602-2), and the interferences are considered different interferences if different sets of receive antennas are used for receiving the PDSCH from the first and second TRPs (602-1 and 602-2).

Embodiment 4: The method of any of embodiments 1 to 3 wherein the first CSI-IM resource is for measuring interference received on a first set of antenna ports for receiving the PDSCH from a first TRP (602-1) associated with the first NZP CSI-RS resource, while the second CSI-IM is for measuring interference received on a second set of antenna ports for receiving the PDSCH from a second TRP (602-2) associated with the second NZP CSI-RS resource.

Embodiment 5: The method of any of embodiments 1 to 4 wherein the NC-JT CSI comprises: a first rank indictor, RI, and a second RI; a first precoding matrix indictor, PMI, and a second PMI; and a first channel quality indicator, CQI.

Embodiment 6: The method of embodiment 5 wherein the NC-JT CSI further comprises a second CQI.

Embodiment 7: The method of embodiment 5 or 6 wherein the NC-JT CSI further comprises a first CSI-RS resource indicator, CRI; a second CRI; or both a first CRI and a second CRI.

Embodiment 8: The method of any of embodiments 1 to 7 wherein the first single TRP CSI comprises a third RI, a third PMI, and a third CQI based on the first NZP CSI-RS resource and the first CSI-IM resource.

Embodiment 9: The method of embodiment 8 wherein the UE (512) assume that the third RI equals to the first RI, and the third PMI equals to the first PMI, wherein the third RI and PMI are not reported.

Embodiment 10: The method of embodiment 8 or 9 wherein the first single TRP CSI may further comprise a fourth RI, a fourth PMI, and a fourth CQI based on the second NZP CSI-RS resource and the second CSI-IM resource.

Embodiment 11: The method of embodiment 10 wherein the UE (512) may assume that the fourth RI equals to the second RI, and the fourth PMI equals to the second PMI, wherein the fourth RI and PMI are not reported.

Embodiment 12: The method of any of embodiments 8 to 11 wherein the first single TRP CSI may further comprises a first CRI, or a second CRI.

Embodiment 13: The method of any of embodiments 1 to 12 wherein the second single TRP CSI comprises the third RI, the third PMI, and the third CQI if an associated CRI is a first value (e.g., CRI=0), and comprises the fourth RI, the fourth PMI, and the fourth CQI if the associated CRI is a second value (e.g., CRI=1).

Embodiment 14: The method of any of the previous embodiments, further comprising: providing user data; and forwarding the user data to a host computer via the transmission to the base station.

### Group B Embodiments

Embodiment 15: A method performed by a network node (800) for configuration of reporting of Channel State Information, CSI, feedback for Non-Coherent Joint Transmission, NC-JT, Physical Downlink Shared Channel, PDSCH, transmission from multiple Transmission/Reception Points, TRPs, (602-1, 602-2), the method comprising: sending (700), to a User Equipment, UE, (512), a CSI reporting setting comprising: a set of Non-Zero Power, NZP, CSI Reference Signal, CSI-RS, resources for channel measurement, the set of NZP CSI-RS resources for channel measurement comprising a first NZP CSI-RS resource for channel measurement and a second NZP CSI-RS resource for channel measurement; and a set of CSI for Interference Measurement, CSI-IM, resources comprising a first CSI-IM resource for interference measurement and a second CSI-IM resource for interference measurement.

Embodiment 16: The method of embodiment 15 wherein the CSI reporting setting further comprises a report quantity identifier indicating a NC-JT CSI report.

Embodiment 17: The method of embodiment 15 or 16 wherein the first CSI-IM resource is for measuring interference received on a first set of antenna ports for receiving a PDSCH from a first TRP (602-1) associated with the first NZP CSI-RS resource, while the second CSI-IM is for measuring interference received on a second set of antenna ports for receiving the PDSCH from a second TRP (602-2) associated with the second NZP CSI-RS resource.

Embodiment 18: The method of any of embodiments 15 to 17 further comprising receiving (step 706) CSI feedback from the UE (512), the CSI feedback comprising: a NC-JT CSI and a first single TRP CSI, or a NC-JT CSI, or a CRI and a second single TRP CSI.

Embodiment 19: The method of embodiment 18 wherein the NC-JT CSI comprises: a first rank indictor, RI, and a second RI; a first precoding matrix indictor, PMI, and a second PMI; and a first channel quality indicator, CQI.

Embodiment 20: The method of embodiment 19 wherein the NC-JT CSI further comprises a second CQI.

Embodiment 21: The method of embodiment 19 or 20 wherein the NC-JT CSI further comprises a first CSI-RS resource indicator, CRI; a second CRI; or both a first CRI and a second CRI.

Embodiment 22: The method of any of embodiments 19 to 21 wherein the first single TRP CSI comprises a third RI, a third PMI, and a third CQI based on the first NZP CSI-RS resource and the first CSI-IM resource.

Embodiment 23: The method of embodiment 22 wherein the UE (512) assume that the third RI equals to the first RI, and the third PMI equals to the first PMI, wherein the third RI and PMI are not reported.

Embodiment 24: The method of embodiment 22 or 23 wherein the first single TRP CSI may further comprise a fourth RI, a fourth PMI, and a fourth CQI based on the second NZP CSI-RS resource and the second CSI-IM resource.

Embodiment 25: The method of embodiment 24 wherein the UE (512) may assume that the fourth RI equals to the second RI, and the fourth PMI equals to the second PMI, wherein the fourth RI and PMI are not reported.

Embodiment 26: The method of any of embodiments 22 to 25 wherein the first single TRP CSI may further comprises a first CRI, or a second CRI.

Embodiment 27: The method of any of embodiments 15 to 26 wherein the second single TRP CSI comprises the third RI, the third PMI, and the third CQI if an associated CRI is a first value (e.g., CRI=0), and comprises the fourth RI, the fourth PMI, and the fourth CQI if the associated CRI is a second value (e.g., CRI=1).

Embodiment 28: The method of any of the previous embodiments, further comprising: obtaining user data; and forwarding the user data to a host computer or a wireless device.

### Group C Embodiments

Embodiment 29: A User Equipment, UE, comprising: processing circuitry configured to perform any of the steps of any of the Group A embodiments; and power supply circuitry configured to supply power to the UE.

Embodiment 30: A network node comprising: processing circuitry configured to perform any of the steps of any of the Group B embodiments; and power supply circuitry configured to supply power to the base station.

Embodiment 31: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 32: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 33: The communication system of the previous embodiment further including the base station.

Embodiment 34: The communication system of the previous 2 embodiments, further including the UE, wherein the UE is configured to communicate with the base station.

Embodiment 35: The communication system of the previous 3 embodiments, wherein: the processing circuitry of the host computer is configured to execute a host application, thereby providing the user data; and the UE comprises processing circuitry configured to execute a client application associated with the host application.

Embodiment 36: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 37: The method of the previous embodiment, further comprising, at the base station, transmitting the user data.

Embodiment 38: The method of the previous 2 embodiments, wherein the user data is provided at the host computer by executing a host application, the method further comprising, at the UE, executing a client application associated with the host application.

Embodiment 39: A User Equipment, UE, configured to communicate with a base station, the UE comprising a radio interface and processing circuitry configured to perform the method of the previous 3 embodiments.

Embodiment 40: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 41: The communication system of the previous embodiment, wherein the cellular network further includes a base station configured to communicate with the UE.

Embodiment 42: The communication system of the previous 2 embodiments, wherein: the processing circuitry of the host computer is configured to execute a host application, thereby providing the user data; and the UE's processing circuitry is configured to execute a client application associated with the host application.

Embodiment 43: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 44: The method of the previous embodiment, further comprising at the UE, receiving the user data from the base station.

Embodiment 45: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 46: The communication system of the previous embodiment, further including the UE.

Embodiment 47: The communication system of the previous 2 embodiments, further including the base station, wherein the base station comprises a radio interface configured to communicate with the UE and a communication interface configured to forward to the host computer the user data carried by a transmission from the UE to the base station.

Embodiment 48: The communication system of the previous 3 embodiments, wherein: the processing circuitry of the host computer is configured to execute a host application; and the UE's processing circuitry is configured to execute a client application associated with the host application, thereby providing the user data.

Embodiment 49: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 50: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 51: The method of the previous embodiment, further comprising, at the UE, providing the user data to the base station.

Embodiment 52: The method of the previous 2 embodiments, further comprising: at the UE, executing a client application, thereby providing the user data to be transmitted; and at the host computer, executing a host application associated with the client application.

Embodiment 53: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 54: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 55: The communication system of the previous embodiment further including the base station.

Embodiment 56: The communication system of the previous 2 embodiments, further including the UE, wherein the UE is configured to communicate with the base station.

Embodiment 57: The communication system of the previous 3 embodiments, wherein: the processing circuitry of the host computer is configured to execute a host application; and the UE is configured to execute a client application associated with the host application, thereby providing the user data to be received by the host computer.

Embodiment 58: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 59: The method of the previous embodiment, further comprising at the base station, receiving the user data from the UE.

Embodiment 60: The method of the previous 2 embodiments, further comprising at the base station, initiating a transmission of the received user data to the host computer.

Some embodiments disclosed herein can be used in any of the following ways:

Proposal 1 Study the order for SVD and port-selection operations, by taking into account the trade-off between UPT, overhead and UE complexity.

Proposal 2 Rel-17 PS codebook should include a DFT-based Wf ∈ [symbol] N3×M(M≥1) as the FD compression matrix.

Proposal 3 Support Alt. 3-0 as it is a robust alternative that allows flexible implementation of Rel-17 enhancements of Type II CSI.

Proposal 4 Multiplexing multiple pairs per CSI-RS port (Of>1) should not be supported as the benefit is not significant (˜5%) and given the increased complexity at UE and gNB and specification impact.

Proposal 5 Prioritize finalizing NC-JT CSI enhancement with single reporting setting in Rel-17 before further discussion of NC-JT CSI enhancement with multiple reporting settings.

Proposal 6 Reducing CSI feedback overhead with 3 or 4 TRPs in a serving cell should be the main goal for NC-JT CSI feedback design.

Proposal 7 For NC-JT CSI enhancement with single reporting setting, support Alt.3.

Proposal 8 If the rank of one of the single TRP CSIs to be reported is above a configured threshold, then the UE may omit CSI associated with NCJT measurement hypothesis.

Proposal 9 When same antennas are used to receive from two TRPs, the interference on the two CSI-IM resources represents two observations of a same interference.

Proposal 10 When different antenna panels are used to receive from two different TRPs, the interference on each of the two CSI-IM resources represent different interference.

Proposal 11 QCL-typeD of an NZP CSI-RS resource for channel measurement should be assumed when measuring interference based on associated CSI-IM and/or another NZP CSI-RS resource.

Proposal 12 In NR Rel-17, unify the Rel-17 MTRP CSI framework enhancements to consider MTRP CSI for both NC-JT and multi-TRP URLLC schemes.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgement
AF Application Function
AMF Access and Mobility Function
AN Access Network
AP Access Point
ASIC Application Specific Integrated Circuit
AUSF Authentication Server Function
BLER Block Error Rate
BWP Bandwidth Part
CE Control Element
CP-OFDM Cyclic Prefix Orthogonal Frequency Division Multiplexing
CPU Central Processing Unit
CQI Channel Quality Indicator
CRI CSI-RS Resource Indicator
CSI Channel State Information
CSI-IM Channel State Information Interference Measurement
CSI-RS Channel State Information Reference Signal
DCI Downlink Channel Information
DFT Discrete Fourier Transform
DL Downlink
DMRS Demodulation Reference Signal
DN Data Network
DSP Digital Signal Processor
eNB Enhanced or Evolved Node B
FPGA Field Programmable Gate Array
gNB New Radio Base Station
gNB-CU New Radio Base Station Central Unit
gNB-DU New Radio Base Station Distributed Unit
HSS Home Subscriber Server
IoT Internet of Things
IP Internet Protocol
LTE Long Term Evolution
MAC Medium Access Control
MCS Modulation and Coding Scheme
MIMO Multiple Input Multiple Output
MME Mobility Management Entity
MTC Machine Type Communication
NC-JT Non-Coherent Joint Transmission
NEF Network Exposure Function
NF Network Function
NR New Radio
NRF Network Function Repository Function
NSSF Network Slice Selection Function
NZP Non-Zero Power
OFDM Orthogonal Frequency Division Multiplexing
OTT Over-the-Top
PC Personal Computer
PCF Policy Control Function
PDCCH Physical Downlink Control Channel
PDSCH Physical Downlink Shared Channel
P-GW Packet Data Network Gateway
PMI Precoding Matrix Indicator
PUCCH Physical Uplink Control Channel
PUSCH Physical Uplink Shared Channel
QCL Quasi Co-Located
QoS Quality of Service
RAM Random Access Memory
RAN Radio Access Network
RB Resource Block
RE Resource Element
RI Rank Indicator
ROM Read Only Memory
RRC Radio Resource Control
RRH Remote Radio Head
RS Reference Signal
RTT Round Trip Time
SCEF Service Capability Exposure Function
SINR Signal to Interference Plus Noise Ratio
SMF Session Management Function
SSB Synchronization Signal Block
TCI Transmission Configuration Indicator
TRP Transmission/Reception Point
UDM Unified Data Management
UE User Equipment
UL Uplink
UPF User Plane Function
ZP Zero Power

Those skilled in the art will recognize improvements and modifications to the embodiments of the present disclosure. All such improvements and modifications are considered within the scope of the concepts disclosed herein.

1. A method performed by a User Equipment, UE, for Channel State Information, CSI, feedback, the method comprising:
receiving, from a network node, a CSI reporting setting comprising:
a set of Non-Zero Power, NZP, CSI Reference Signal, CSI-RS, resources for channel measurement, the set of NZP CSI-RS resources for channel measurement comprising a first NZP CSI-RS resource for channel measurement, a second NZP CSI-RS resource for channel measurement, a third NZP CSI-RS resource for channel measurement, and a fourth NZP CSI-RS for channel measurement; and
computing and reporting CSI feedback corresponding to the CSI reporting setting comprising:
a first CSI comprising at least a first rank indicator, RI, and a first precoding matrix indicator, PMI, associated with the first NZP CSI-RS resource for channel measurement, and a second RI and a second PMI associated with the second NZP CSI-RS resource for channel measurement; and
at least one of a second CSI and a third CSI, wherein
the second CSI comprises at least a third RI and a third PMI associated with the third NZP CSI-RS resource for channel measurement, and
the third CSI comprises at least a fourth RI and a fourth PMI associated with the fourth NZP CSI-RS resource for channel measurement.

2. The method of claim 1 wherein the first CSI further comprises a first channel quality indicator, CQI.

3. The method of claim 1, wherein the first CSI further comprises a first CSI-RS resource indicator, CRI; a second CRI; or both a first CRI and a second CRI.

4. The method of claim 1, wherein the second CSI comprises a second CQI.

5. The method of claim 1, wherein the third CSI comprises a third CQI.

6. The method of claim 1, wherein the second CSI further comprises a third CRI.

7. The method of claim 1, wherein the third CSI further comprises a fourth CRI.

8. The method of claim 1, wherein the first NZP CSI-RS resource for channel measurement is the same as the third NZP CSI-RS resource for channel measurement.

9. The method of claim 1, wherein the second NZP CSI-RS resource for channel measurement is the same as the fourth NZP CSI-RS resource for channel measurement.

10. The method of claim 1, wherein the CSI reporting setting further comprises a configuration of a Channel State Information Interference Measurement, CSI-IM, resource associated with the first and the second NZP CSI-RS resources.

11. The method of claim 1, wherein the UE operates in a New Radio (NR) communications network.

12. A method performed by a network node for configuration of reporting of Channel State Information, CSI, feedback, the method comprising:
sending, to a User Equipment, UE, a CSI reporting setting comprising:
a set of Non-Zero Power, NZP, CSI Reference Signal, CSI-RS, resources for channel measurement, the set of NZP CSI-RS resources for channel measurement comprising a first NZP CSI-RS resource for channel measurement and a second NZP CSI-RS resource for channel measurement, a third NZP CSI-RS resource for channel measurement, and a fourth NZP CSI-RS for channel measurement.

13. The method of claim 12 further comprising receiving CSI feedback corresponding to the CSI reporting setting, from the UE, the CSI feedback comprising:
a first CSI comprising at least a first rank indicator, RI, and a first precoding matrix indicator, PMI, associated with the first NZP CSI-RS resource for channel measurement, and a second RI and a second PMI associated with the second NZP CSI-RS resource for channel measurement; and
at least one of a second CSI and a third CSI, wherein
the second CSI comprises at least a third RI and a third PMI associated with the
third NZP CSI-RS resource for channel measurement, and
the third CSI comprises at least a fourth RI and a fourth PMI associated with the fourth NZP CSI-RS resource for channel measurement.

14. The method of claim 12 wherein the first CSI further comprises:
a first channel quality indicator, CQI.

15. The method of claim 12, wherein the first CSI further comprises a first CSI-RS resource indicator, CRI; a second CRI; or both a first CRI and a second CRI.

16. The method of claim 12, wherein the second CSI comprises a second CQI.

17. The method of claim 12, wherein the third CSI comprises a third CQI.

18. The method of claim 12, wherein the second CSI further comprises a third CRI.

19. The method of claim 12, wherein the third CSI further comprises a fourth CRI.

20. The method of claim 12, wherein the first NZP CSI-RS resource for channel measurement is the same as the third NZP CSI-RS resource for channel measurement.

21. The method of any of claim 12, wherein the second NZP CSI-RS resource for channel measurement is the same as the fourth NZP CSI-RS resource for channel measurement.

22. The method of claim 12, wherein the CSI reporting setting further comprises a configuration of a Channel State Information Interference Measurement, CSI-IM, resource associated with the first and the second NZP CSI-RS resources.

23. A User Equipment, UE, for Channel State Information, CSI, feedback, the UE comprising:
one or more transmitters;
one or more receivers; and
processing circuitry associated with the one or more transmitters and the one or more receivers, the processing circuitry configured to cause the wireless device to:
receive, from a network node, a CSI reporting setting comprising:
a set of Non-Zero Power, NZP, CSI Reference Signal, CSI-RS, resources for channel measurement, the set of NZP CSI-RS resources for channel measurement comprising a first NZP CSI-RS resource for channel measurement, a second NZP CSI-RS resource for channel measurement, a third NZP CSI-RS resource for channel measurement, and a fourth NZP CSI-RS for channel measurement; and
compute and report CSI feedback corresponding to the CSI reporting setting comprising:
a first CSI comprising at least a first rank indicator, RI, and a first precoding matrix indicator, PMI, associated with the first NZP CSI-RS resource for channel measurement, and a second RI and a second PMI associated with the second NZP CSI-RS resource for channel measurement; and
at least one of a second CSI and a third CSI, wherein
the second CSI comprises at least a third RI and a third PMI associated with the third NZP CSI-RS resource for channel measurement, and
the third CSI comprises at least a fourth RI and a fourth PMI associated with the fourth NZP CSI-RS resource for channel measurement.

24. (canceled)

25. A network node for configuration of reporting of Channel State Information, CSI, feedback for Non-Coherent Joint Transmission, NC-JT, Physical Downlink Shared Channel, PDSCH, transmission from multiple Transmission/Reception Points, TRPs, the network node comprising:
one or more transmitters;
one or more receivers; and
processing circuitry associated with the one or more transmitters and the one or more receivers, the processing circuitry configured to cause the radio access node to:
send, to a User Equipment, UE, a CSI reporting setting comprising:
a set of Non-Zero Power, NZP, CSI Reference Signal, CSI-RS, resources for channel measurement, the set of NZP CSI-RS resources for channel measurement comprising a first NZP CSI-RS resource for channel measurement and a second NZP CSI-RS resource for channel measurement, a third NZP CSI-RS resource for channel measurement, and a fourth NZP CSI-RS for channel measurement.

26. (canceled)
